(19) United States
(12) Patent Application Publication
(10) Pub. No.: US 2021/0049242 A1
(43) Pub. Date: Feb. 18, 2021

(54) Process Optimization by Clamped Monte Carlo Distribution

(71) Applicant: international Business Machines Corporation, Armonk, NY (US)

(72) Inventors: Scott Halle, Slingerlands, NY (US); Derren Dunn, Sandy Hook, CT (US); Nelson Felix, Slingerlands, NY (US); Dhiraj Gupta, San Mateo, CA (US)

(21) Appl. No.: 16/539,809

(22) Filed: Aug. 13, 2019

(51) Int. Cl. G06F 17/50

(52) U.S. Cl. CPC G06F 17/5009; G06F 2217/16; G06F 2217/10

(57) ABSTRACT

Techniques for semiconductor process flow disposition optimization using clamped Monte Carlo distribution are provided. In one aspect, a method for optimizing a semiconductor fabrication process includes: providing a model of the fabrication process; identifying sensitive parameters of the fabrication process using Monte Carlo simulations that sample sections of experimental parameter populations from the fabrication process as input to the model to determine parameters which impact an outcome of the Monte Carlo simulations, wherein the parameters which impact the outcome of the Monte Carlo simulations are the sensitive parameters; bounding the experimental parameter populations of the sensitive parameters to improve the outcome of the Monte Carlo simulations; and modifying the fabrication process based on the providing, identifying and bounding steps to improve an output of the fabrication process.

### FIELD OF THE INVENTION

The present invention relates to semiconductor process flow disposition optimization, and more particularly, to techniques for semiconductor process flow disposition optimization using clamped Monte Carlo distribution.

### BACKGROUND OF THE INVENTION

Determining the critical parameters which dominate the characteristic outcome distribution (e.g., pitch walk control) of a complex multi-step semiconductor process flow such as Self-Aligned Quadruple Patterning (SAQP) are quite difficult. Typically, engineers will run a variety of experimental binary splits to understand the process. Binary splitting is a technique for numerical evaluation of series with rational terms. These binary splitting techniques are, however, time consuming and expensive for most applications.

Further, use of a binary splitting approach may or may not capture the complete process statistical view and understanding of the combinatorial nature of all the process interactions. Additionally, the tradeoff between the variance control of the disposition process and the variance of the outcome critical parameter are often poorly understood.

Accordingly, improved techniques for process flow disposition optimization would be desirable.

### SUMMARY OF THE INVENTION

The present invention provides techniques for semiconductor process flow disposition optimization using clamped Monte Carlo distribution. In one aspect of the invention, a method for optimizing a semiconductor fabrication process is provided. The method includes: providing a model of the fabrication process; identifying sensitive parameters of the fabrication process using Monte Carlo simulations that sample sections of experimental parameter populations from the fabrication process as input to the model to determine parameters which impact an outcome of the Monte Carlo simulations, wherein the parameters which impact the outcome of the Monte Carlo simulations are the sensitive parameters; bounding the experimental parameter populations of the sensitive parameters to improve the outcome of the Monte Carlo simulations; and modifying the fabrication process based on the providing, identifying and bounding steps to improve an output of the fabrication process.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary methodology for optimizing a semiconductor fabrication process according to an embodiment of the present invention;

FIG. 2 is a diagram illustrating validation of pitch walking predictions for a Self-Aligned Quadruple Patterning (SAQP) process according to an embodiment of the present invention;

FIG. 3 is a histogram illustrating an exemplary experimental parameter data population for a fabrication process (e.g., SAQP) and the restricted population selected for Monte Carlo simulation according to an embodiment of the present invention;

FIG. 4 is a histogram illustrating outcome distributions of a Monte Carlo simulation with an experimental pitch walk population distribution plotted as a function of standard deviation according to an embodiment of the present invention;

FIG. 5 is a histogram illustrating a mean shift of the simulation population distribution from restricting the Monte Carlo population from FIG. 3 relative to the experimental pitch walk population in units of standard deviation according to an embodiment of the present invention;

FIG. 6 is a diagram illustrating an exemplary methodology for sensitivity analysis according to an embodiment of the present invention;

FIG. 7A is a histogram illustrating an exemplary population having kσ bins according to an embodiment of the present invention;

FIG. 7B is a histogram illustrating sampling a section of an experimental parameter data population (e.g., for spacer thickness) plotted versus kσ bins according to an embodiment of the present invention;

FIG. 8 is a histogram illustrating a mean shift of the pitch walk simulation population distribution from restricting the Monte Carlo population from FIG. 7B plotted as a function of pitch walk standard deviation according to an embodiment of the present invention;

FIGS. 9A-C are histograms illustrating, for a single input parameter, restricting/sampling a section of an experimental parameter pitch walk data population and the corresponding mean shift of the pitch walk simulation population distribution based on the restriction according to an embodiment of the present invention;

FIGS. 10A-C are histograms further illustrating, for the single input parameter, restricting/sampling a section of an experimental parameter pitch walk data population and the corresponding mean shift of the pitch walk simulation population distribution based on the restriction according to an embodiment of the present invention;

FIGS. 11A-C are histograms illustrating, for another single input parameter, restricting/sampling a section of an experimental parameter pitch walk data population and the corresponding mean shift of the pitch walk simulation population distribution based on the restriction according to an embodiment of the present invention;

FIGS. 12A-C are histograms further illustrating, for the other single input parameter, restricting/sampling a section of an experimental parameter pitch walk data population and the corresponding mean shift of the pitch walk simulation population distribution based on the restriction according to an embodiment of the present invention;

FIG. 13 is a histogram illustrating a section of the experimental parameter pitch walk data having been bounded to cut the edges of the population distribution according to an embodiment of the present invention;

FIG. 14 is a histogram illustrating the resulting outcome distributions from the experimental pitch walk data from performing the Monte Carlo simulations on the bounded population from FIG. 13 according to an embodiment of the present invention;

FIG. 15 is a diagram illustrating the continuous change (i.e., improvement of the pitch walk process) of the standard deviation of the pitch walk population as a function of the clamped kσ width of an experimental parameter according to an embodiment of the present invention;

FIG. 16 is a diagram illustrating an exemplary apparatus that can be employed in carrying out one or more of the present techniques according to an embodiment of the present invention; and

FIG. 17 is a diagram illustrating a quadruple patterning (SAQP) process according to an embodiment of the present invention.

### DETAILED DESCRIPTION OF PREFERRED EMBODIMENTS

As provided above, the use of conventional approaches such as binary splitting to determine which parameters dominate the characteristic outcome distribution of a complex multi-step semiconductor process flow are typically time consuming and expensive, and oftentimes do not provide a comprehensive insight into the nature of all of the process interactions involved. Advantageously, provided herein are techniques for quantitatively determining the process sensitivity of a given step in a complex multistep process that controls the downstream process critical dimension (CD) structural stack parameter such as Self-Aligned (or Spacer-Assisted) Quadruple Patterning (SAQP) pitch walk control. Namely, as will be described in detail below, the present techniques identify what the key sensitive parameters are, and what the relative contribution of these key sensitive parameters are to CD outcome.

For instance, using the identified sensitive parameters, a determination is made of the expected variance improvement of a downstream process CD structural stack parameter as a function of restricting or clamping the variance (i.e., restricting the variance to a given range) of the key sensitive parameters. This disposition technique can be applied, either as a standard process disposition or after regression-based predictive models highlight the need for substantial corrective action.

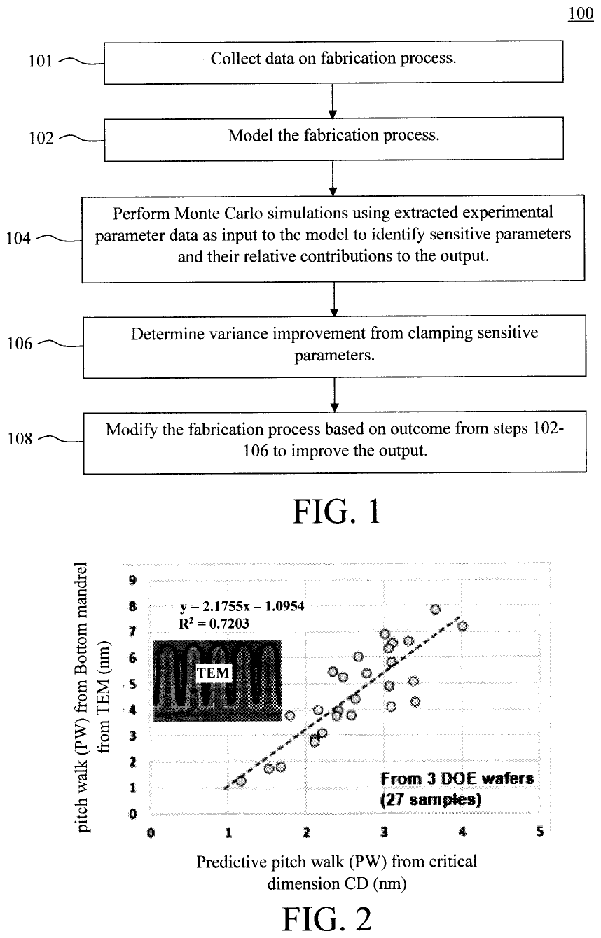

The present techniques are now described by way of reference to methodology 100 of FIG. 1 for optimizing a semiconductor fabrication process. As will be apparent from the description of methodology 100 that follows, the present techniques employ machine learning for semiconductor process geometrical parameter sensitivity analysis and process variance improvement by restricting the parameter distributions of the machine learning process (e.g., via clamped Monte Carlo simulations—see below) in order to assess the impact of a parameter on the output of the process.

The goal is to be able to identify the parameters in a multi-step process that affect the outcome downstream, and by how much, in order to know what upstream parameters to control in order to achieve a desired downstream outcome. For instance, SAQP is a tightly-coupled, multi-step process, where what happens in one step might depend on what happens in one or more upstream steps, and so on. These dependencies are, however, not always apparent, and it is the goal of the present techniques to identify sensitivities among parameters to enable a user to know what parameters to control in order to affect a downstream outcome, and by how much. Using SAQP as an example, as will be described in detail below, this process involves the deposition, patterning, etc. of multiple materials in a variety of different steps. It may not always be apparent what impact, if any, a certain parameter (such as the thickness of a given spacer) has on what downstream outcome, and what is the magnitude of that impact. By way of the present techniques, a user can determine which of the multi parameters of the SAQP process to tune in order to achieve a desired downstream outcome.

As highlighted above, according to an exemplary embodiment the present techniques employ Monte Carlo methods which are based on probability distributions extracted from experimental parameter data. As is known in the art, a Monte Carlo method is a statistical technique for modelling stochastic systems to determine the probable outcomes from the system based on random inputs. The Monte Carlo method can be used to model systems involving complex interactions of many variables.

For illustrative purposes only, semiconductor fabrication process examples will be referenced in the description of methodology 100. For instance, one such process is SAQP. SAQP is a process that can be employed to pattern features at pitches smaller than achievable using direct patterning. Namely, SAQP enables the patterning of wider features, followed by two successive cycles of spacer deposition (i.e., Spacer 1 and Spacer 2), spacer etch, and core removal.

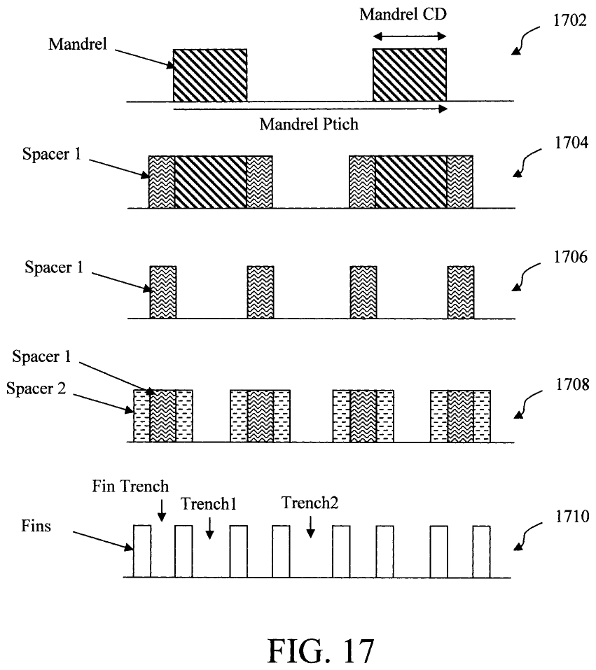

Referring briefly to FIG. 17, SAQP generally involves first forming mandrels on a substrate (see step 1702), forming Spacers 1 on opposite sides of the mandrels (see step 1704), removing the mandrels (see step 1706), forming Spacers 2 on opposite sides of the Spacers 1 (see step 1708), removing Spacers 1, and then using Spacers 2 as a hardmask to pattern the substrate (see step 1710). Based on this process, there are four Spacers 2 for each mandrel initially formed on the substrate. Thus, SAQP is a pitch quadrupling process. Other pitch multiplying processes that can be optimized using the present techniques include, but are not limited to, sidewall image transfer (SIT) which employs two spacers for every mandrel formed, and thus is a pitch doubling process. Further increases to the pattern density through SAQP can be achieved using top mandrels (TM) and bottom mandrels (BM) which repeat the above-described spacer formation and pattern transfer steps at multiple (top/bottom) levels of the patterning structure.

While SAQP allows patterning at sub-lithographic pitches, it also involves more process steps, more complex interactions of the associated lithography and etching processes, and hence more chances for variation. One such process variation is pitch walking (PW). Pitch walking occurs when the lithography, material deposition and/or etching process involved in SAQP generates a repeating, non-uniform grating of space and line critical dimensions. While an SAQP is a good example to use to illustrate methodology 100, it is to be understood that the present techniques are more broadly applicable to any stochastic process including, but not limited to, processes involved in semiconductor fabrication.

As shown in FIG. 1, methodology 100 begins in step 101 by collecting data for the semiconductor fabrication process being optimized. For example, using SAQP as an example, the data collected in step 101 can include, but is not limited to, spacer thickness, mandrel critical dimension (CD), mandrel pitch etc. This data can be obtained from actual past production runs of the fabrication process whereby analytic tools such as transmission electron microscopy (TEM) imaging are used to measure the outcome product.

In step 102, the fabrication process is modeled. According to an exemplary embodiment, an analytical model is employed having equations that describe downstream outcome critical dimensions (CD) based on upstream input parameters. For instance, by way of example only, a set of analytical equations can be employed for evaluating the outcome CD of an SAQP process based on input parameters such as the thicknesses of Spacer 1 and Spacer 2 (T_{SP1} and T_{SP2}), mandrel CD and pitch (CD_{Mandrel} and Pitch_{Mandrel}), etc. For example,

CD_{Fin}=T_{SP2} (1)

CD_{FinTrench}=T_{SP1} (2)

CD_{Trench1}=CD_{Mandrel}−2*(T_{SP2}) (3)

CD_{Trench2}=Pitch_{Mandrel}−CD_{Mandrel}−2*(T_{SP1})−2*(T_{SP2}) (4)

wherein Fin Trench refers to the trench between fins from the same Spacer 1, Trench 1 refers to the trench between fins from adjacent Spacers 1, and Trench 2 refers to the trench between fins from adjacent mandrels.

To use a simple example, referring to Equation 1, the critical dimension of the fins patterned in the substrate via the Spacers 2, i.e., CD_{Fin}, is equivalent to the thickness of Spacer 2, i.e., T_{SP2}. Thus, the model is based on structural wafer stack geometries (e.g., space width=pitch−width of structure) that describe a single step or multiple steps of the fabrication process.

Further, the equations which describe tightly-coupled, multi-step processes can be analytically coupled. For instance, again using Equations 1-4 above as an example, the outcome CD of the trench gap CD_{Trench2} is dependent on a combination of parameters, e.g., Pitch_{Mandrel}, CD_{Mandrel}, T_{SP1} and T_{SP2}. See, e.g., Equation 4. It is noted that these analytical equations for an SAQP process are only being used herein as an illustrative example. The present techniques are broadly applicable to any stochastic fabrication process and can be implemented using a variety of different models as would be apparent to one skilled in the art.

FIG. 2 depicts how pitch walking (PW) predictions made using the (analytical) model correlate with actual measurements taken from, e.g., a transmission electron microscopy (TEM) image—see inset TEM image. Namely, the plot in FIG. 2 shows the linear correlation of the experimentally measured pitch walk (PW) of the mandrel in the SAQP process (on the Y-axis) versus the model prediction of the pitch walk (on the X-axis). Preferably, the analytical equations of the model are validated experimentally in this manner (e.g., as shown in FIG. 2, experimental data from 27 wafer samples was used to validate the model).

As will be described in detail below, simulations will be run with the model using actual experimental data to determine probable outcomes. Thus, metrology data is needed for extracting these experimental values of the relevant geometrical quantities from the fabrication process that are used for the experimental parameter values of the analytic equations in the model (e.g., N sets of experimental parameter values would be needed for the n steps of a complex, multi-step fabrication process). By way of non-limiting example only, a scatterometry-based metrology is suitable for extracting this experimental parameter data. Scatterometry is a non-destructive method to assess detailed structural requirements.

In step 104, Monte Carlo simulations are performed based on probability distributions extracted from experimental parameter data being used as input to the model (from step 102) to: i) identify sensitive parameters, i.e., those parameters of the fabrication process which impact the outcome of the simulations (for example, identify which parameters, if varied, impact (i.e., reduce) pitch walking variance in the simulations), and ii) determine the relative contribution these identified sensitive parameters have to that outcome. See step 106, described below. The terms “upstream” and “downstream” are used herein to describe the relative order of steps/outcomes in a fabrication process flow. For instance, in an SAQP process flow, mandrel formation occurs upstream from spacer formation, and trench patterning using the spacers is downstream from the mandrel and spacer formation, and so on.

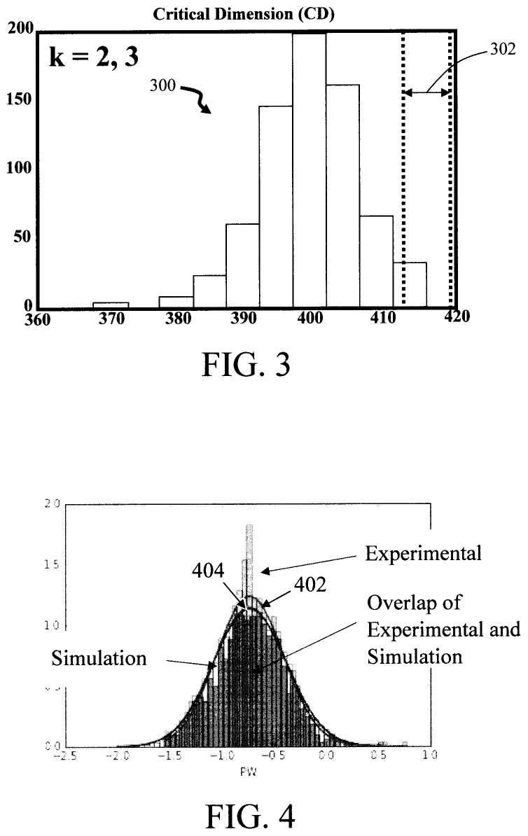

As provided above, Monte Carlo simulations are used to determine the probable outcomes from a stochastic system. The Monte Carlo simulations in the present process are based on experimental parameter data. See, for example, the histogram in FIG. 3 which illustrates a population 300 of experimental parameter data for CD_{Mandrel} having kσ bins, wherein σ is the standard deviation, and k is a multiplier of the standard deviation, i.e., k sets the granularity of the standard deviation/variance. The experimental parameter data is obtained from actual runs of the fabrication process where parameter and output measurements are made. In this manner, distributions will be provided for each of the parameters of the fabrication process in order to identify the sensitive parameters. Thus, population 300 is only one representative example.

To identify the sensitive parameters, the population is restricted (for a given input parameter such as critical dimension (CD) width), e.g., to μ+kσ(k=2,3), wherein μ is the mean, in the present example (see FIG. 3), and a Monte Carlo simulation is performed using that restricted input parameter population as input to the model (from step 102) (the restricted population selected for Monte Carlo simulation may also be referred to herein as the Monte Carlo population). Thus, by this process the Monte Carlo simulation is performed on a sampled section of the input parameter population. See FIG. 4. FIG. 4 is a histogram illustrating the outcome distributions, i.e., an experimental population distribution (labeled “Experimental”) with associated gaussian fit 402, a simulation population distribution from the Monte Carlo simulation (labeled “Simulation”) with associated gaussian fit 404, and the overlap distribution (labeled “Overlap of Experimental and Simulation”). As provided above, the experimental population distribution data is derived from actual runs of the fabrication process where parameter and output measurements are made. Thus, the Monte Carlo simulations are validated based on actual experimental data.

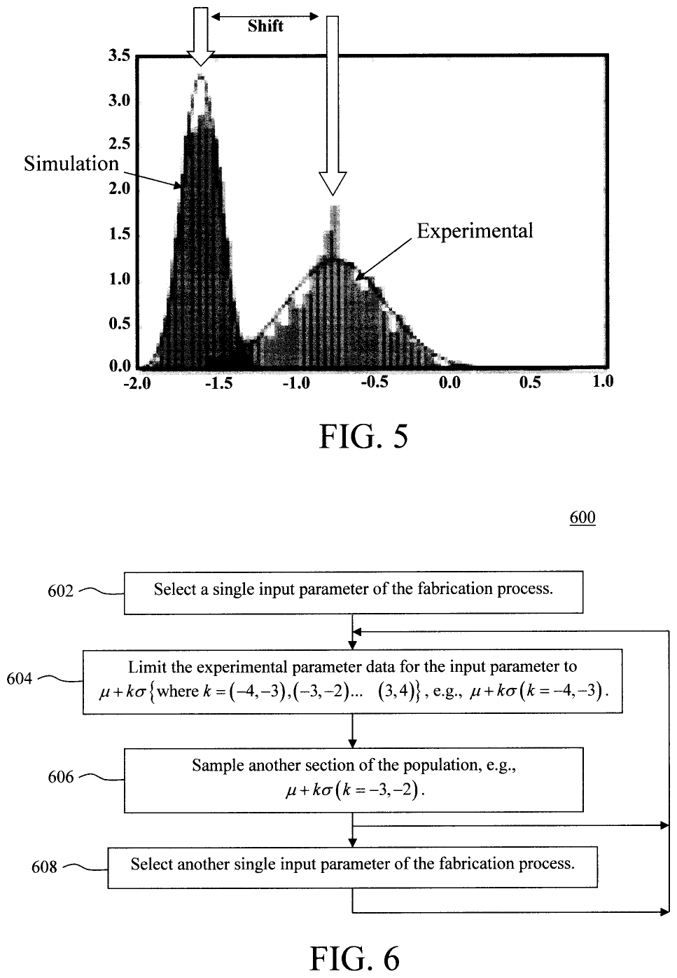

The sensitive parameters are identified by assessing the impact this restriction (sampling) has on the outcome simulation population distribution which is representative of the impact the sensitive parameters have on the outcome of the process. See, for example, FIG. 5. In this example, population 300 is restricted to μ+kσ(k=2,3) shown in window 302 (see FIG. 3) resulting, as shown in the histogram in FIG. 5 (outcome distributions), in a shift of the simulation population distribution with respect to the experimental population distribution in units of standard deviation. According to an exemplary embodiment, a SAQP process is being modeled and the shift of the simulation population distribution represents pitch walk variance in the output. As described above, pitch walking occurs when the lithography, material deposition and/or etching process involved in SAQP generates a repeating, non-uniform grating of space and line critical dimensions.

Those parameters that have an impact on the simulation population distribution (such as those modeled in FIGS. 3-5) are sensitive parameters for that fabrication process. Further, this ‘impact’ is also used as a measure of the degree of sensitivity, whereby the greater the impact, the larger the sensitivity. Knowing the extent of the impact a given parameter has on the output is extremely useful for optimizing a fabrication process. For instance, knowing what parameters in a SAQP process have the greatest impact on pitch walking enables a user to make an informed selection of which upstream parameters to regulate in order to obtain a desired output specification (i.e., to actively reduce pitch walking variance). As highlighted above, the way a given parameter in a fabrication process affects the output is not always obvious, and the present techniques provide an efficient and effective tool to elaborate these correlations.

To further illustrate the sensitivity analysis performed in step 104, reference is now made to exemplary methodology 600 of FIG. 6. In step 602, a single input parameter for the fabrication process is selected. For instance, by way of example only, in a SAQP process one might select CD_{Mandrel} in step 602.

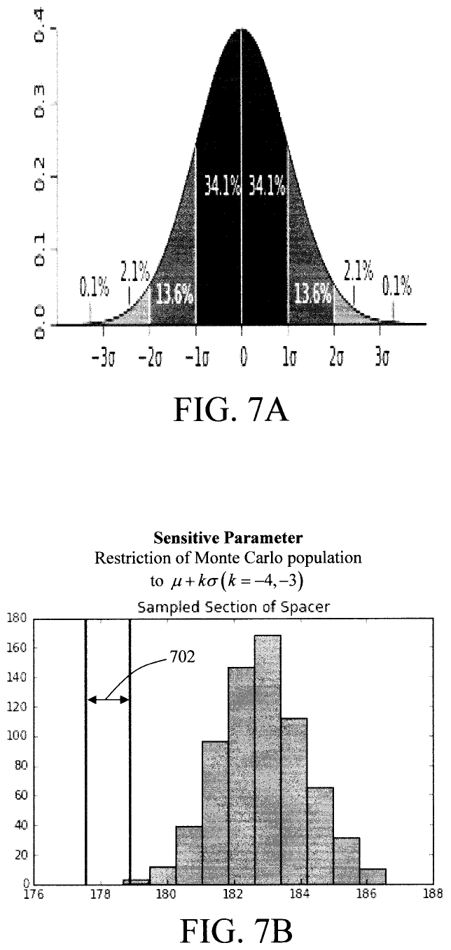

As provided above, the Monte Carlo simulation is performed on a restricted (or ‘clamped’) population of the experimental parameter data. Thus, in step 604 the population for the single input parameter selected in step 106 is limited to μ+kσ{where k=(−4,−3), (−3,−2) . . . (3,4)}, wherein μ is the mean. This process for limiting the Monte Carlo population is further illustrated in FIGS. 7A and 7B. First, referring to FIG. 7A, as highlighted above, the experimental parameter data for each input parameter can be represented as a distribution having kσ bins. FIG. 7B illustrates the sampling of a section of that distribution (see window 702) by restricting the population to μ+kσ(k=−4,−3).

The Monte Carlo simulation is performed using that restricted (sampled) population (i.e., the Monte Carlo population) as input to the model, and in step 606 the shift of the mean μ for the simulation population distribution with respect to the experimental population distribution is measured to determine an impact the restriction of the Monte Carlo population has on the outcome (e.g., in a SAQP process where output variation is an indicator of pitch walking variance). For each parameter, the notion is that the larger the mean shift, the greater the sensitivity of the parameter. Further, the present techniques serve to normalize all of the parameters as a function of kσ thereby allowing one to evaluate (i.e., rank) different parameters at the same scale.

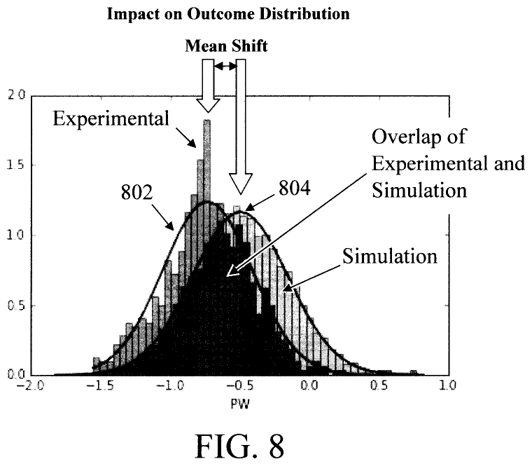

See, for example, the outcome distributions in FIG. 8. As shown in FIG. 8, the Monte Carlo simulation on the restricted population μ+kσ(k =−4,−3) (see FIG. 7B, window 702) results in a mean μ* shift of the pitch walk (PW) simulation population distribution (from the Monte Carlo simulation) with respect to the experimental population distribution. Namely, FIG. 8 depicts an experimental population distribution (labeled “Experimental”) with associated gaussian fit 802, a simulation population distribution from the Monte Carlo simulation (labeled “Simulation”) with associated gaussian fit 804, and the overlap distribution (labeled “Overlap of Experimental and Simulation”).

In step 606, another section of the population is sampled with another selection from k=(−4,−3),(−3,−2) . . . (3,4), and a Monte Carlo simulation is run on that sampled (Monte Carlo population). For instance, if in step 604 μ+kσ(k =−4,−3), then in step 606 μ+kσ(k=−3,−2), and so on. Steps 604 and 606 are then repeated until all of sections μ+kσwhere k={(−4,−3), (−3,−2) . . . (3,4)} have been sampled.

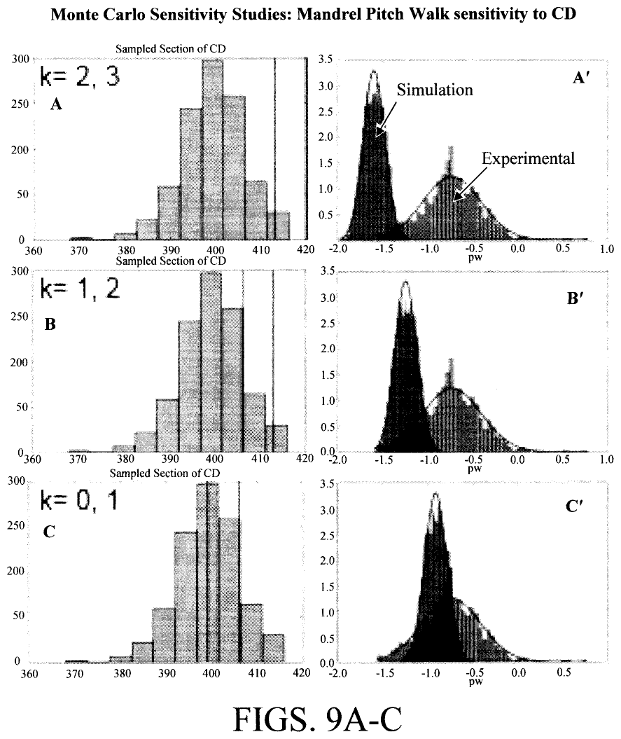

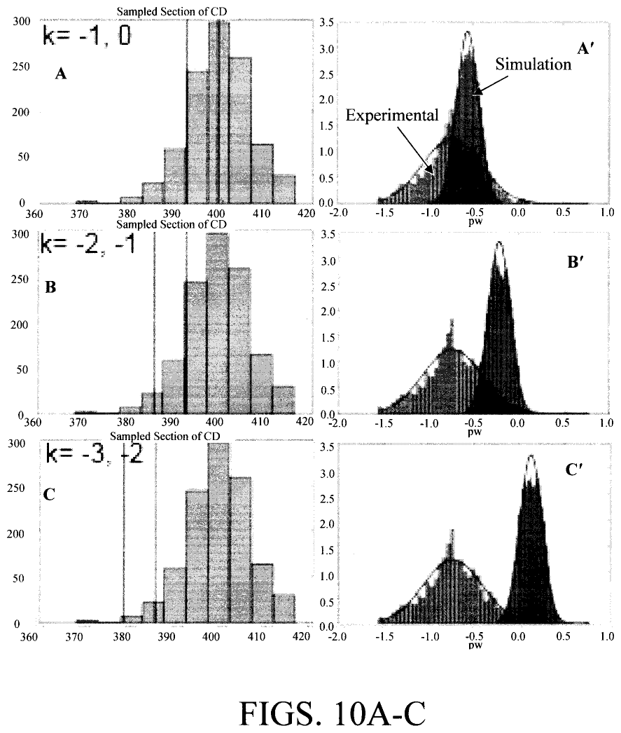

See, for example, FIGS. 9A-C and 10A-C which provide an illustrative example of multiple iterations of steps 604 and 606 having being performed for a given input parameter (in this case CD_{Mandrel}). In each iteration, the sampled section of the pitch walk (PW) population (plotted in arbitrary nm units) is depicted in FIGS. 9/10 A, B, C, and the corresponding outcome distributions, i.e., experimental population distribution (labeled “Experimental”) and pitch walk (PW) simulation population distribution from the Monte Carlo simulation are depicted in FIGS. 9/10 A′, B′, C′, respectively. For instance, in FIG. 9A the sampled section of the population μ+kσ(k=2,3) is shown, while the corresponding Monte Carlo simulation population distribution (and mean shift relative to the experimental population distribution) is shown in FIG. 9A′. Similarly, the sampled section of the population μ+kσ(k =1,2) is shown in FIG. 9B, while the corresponding Monte Carlo simulation population distribution (and mean shift relative to the experimental population distribution) is shown in FIG. 9B′. Each FIGS. 9A/9A′, 9B/9B′ . . . 10C/10C′ depicts one iteration of steps 604 and 606. The progression from FIGS. 9A/9A′ to FIGS. 10C/10C′ illustrates a tightening effect of CD control on the pitch walk.

Once all of sections μ+kσ{where k=(−4,−3) ,(−3,−2) . . . (3,4)} for the given input parameter have been sampled, in step 608 another input parameter is selected. As shown in FIG. 6, steps 604-608 are then repeated with the updated parameter.

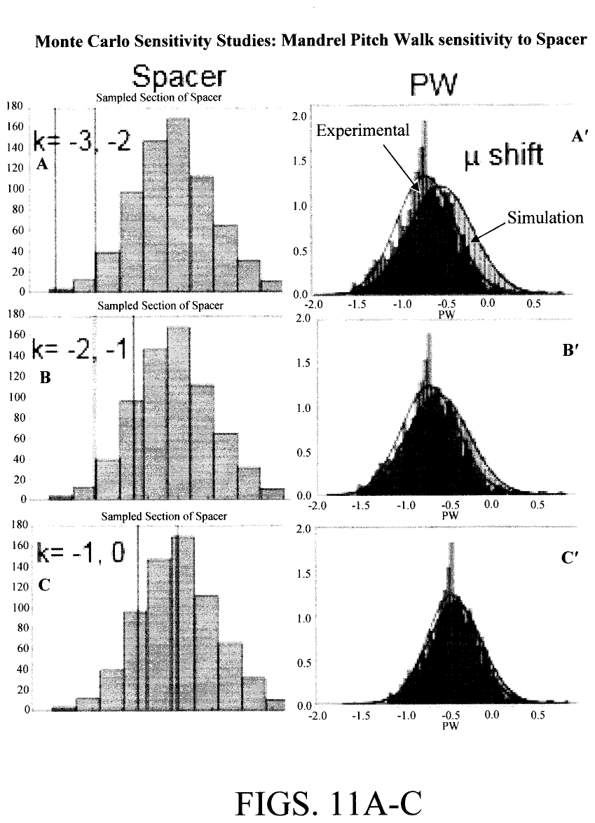

See, for example, FIGS. 11A-C and 12A-C which provide an illustrative example of multiple iterations of steps 604 and 606 having being performed for the next input parameter (in this case T_{Spacer1}). In each iteration, the sampled section of the pitch walk (PW) population (plotted in arbitrary nm units) is depicted in FIGS. 11/12 A, B, C, and the corresponding experimental population distribution (labeled “Experimental”) and pitch walk (PW) simulation population distribution from the Monte Carlo simulation are depicted in FIGS. 11/12 A′, B′, C′, respectively. For instance, in FIG. 11A the sampled section of the population μ+kσ(k =−3,−2) is shown, while the corresponding Monte Carlo simulation population distribution (and mean shift relative to the experimental population distribution) is shown in FIG. 11A′. Similarly, the sampled section of the population μ+kσ (k=−2,−1) is shown in FIG. 11B, while the corresponding Monte Carlo simulation population distribution (and mean shift relative to the experimental population distribution) is shown in FIG. 11B′. Each FIGS. 11A/11A′, 11B/11B′ . . . 12C/12C′ depicts one iteration of steps 604 and 606 with updated input parameter.

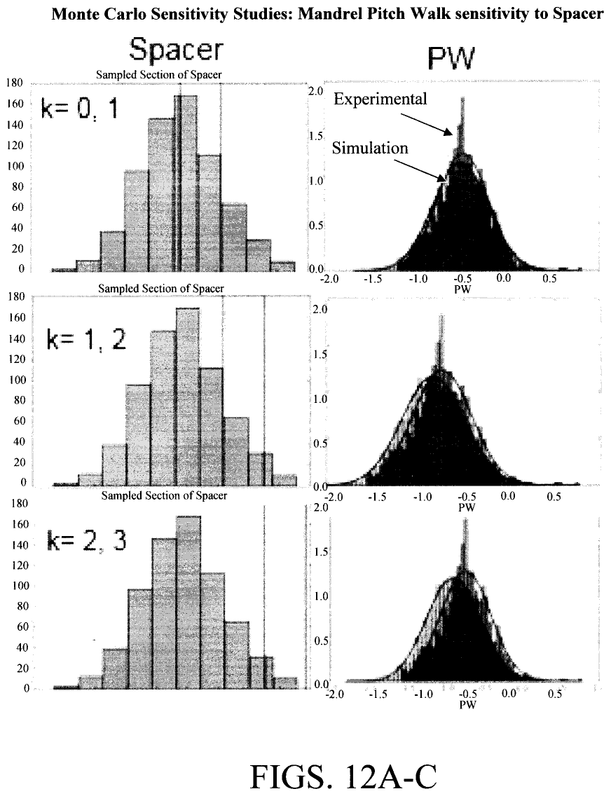

From the examples provided in FIGS. 9-12 it can be seen that the sensitivity of certain parameters of the fabrication process is greater than others. For instance, variation in the parameter CD_{Mandrel} has a greater impact on pitch walking than variations in the T_{Spacer1}. This can be seen by comparing the results shown in FIGS. 9 and 10 (CD_{Mandrel}) with those shown in FIGS. 11 and 12 (T_{Spacer1}). Namely, variations in CD_{Mandrel} result in a relatively greater mean shift in the Monte Carlo simulation population distributions relative to the experimental population distributions as compared to T_{Spacer1}. Thus, efforts towards pitch walk variance improvement might be better focused on controlling CD_{Mandrel} variation, as opposed to T_{Spacer1} variation.

Referring back to methodology 100 of FIG. 1, once the sensitive parameters of the fabrication process have been identified, an expected variance improvement of a downstream process critical dimension as a function of bounding (i.e., clamping) the variance of the sensitive parameters is determined. See step 106. The goal is to determine how much clamping of the kσ is needed to improve the outcome distribution of the Monte Carlo simulation. To do so, the population of at least one of the sensitive parameters (identified above) is bounded to cut the edges of the population, i.e.,

μ+kσ{for k=(−4,4),(−3,3),(−2,2),(−1,1)}

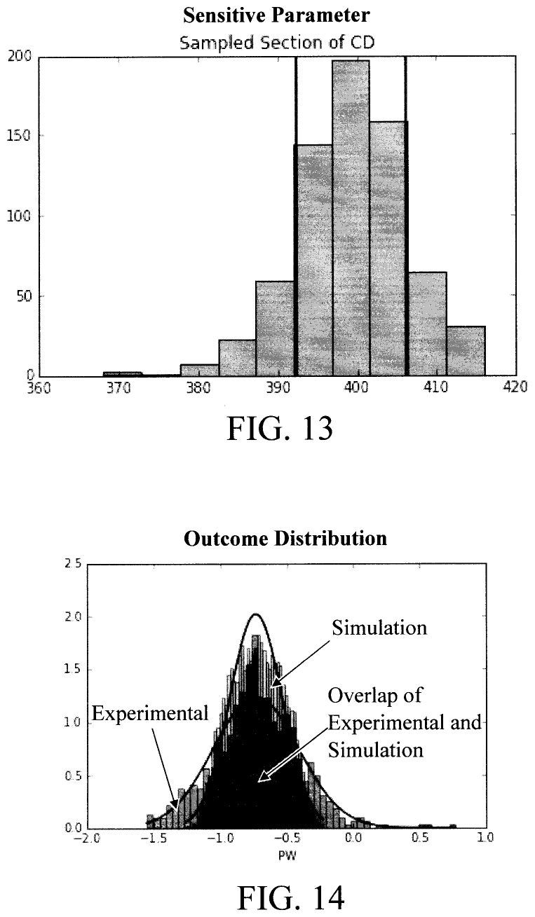

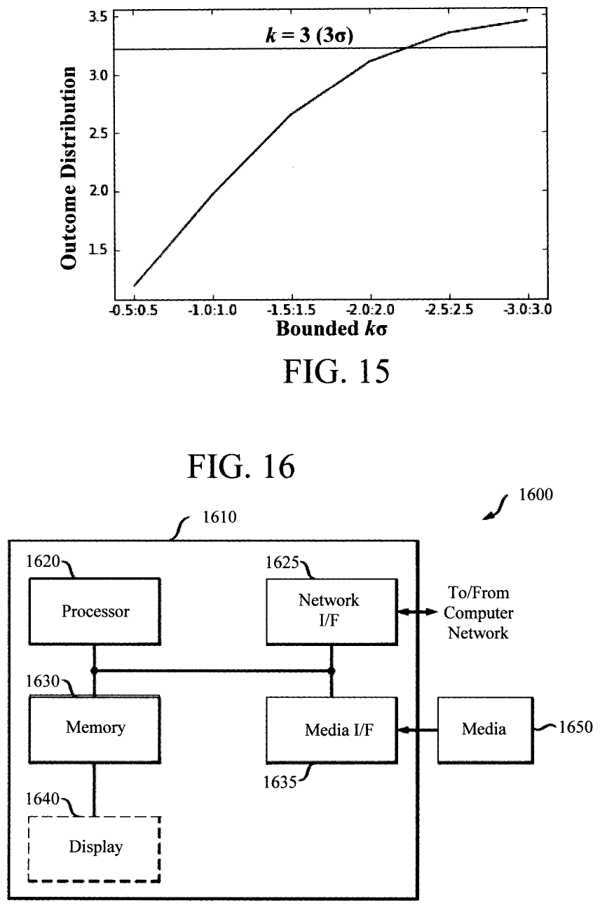

See, for example, FIGS. 13-15 which provide an illustrative example of bounding a sensitive parameter to reduce variance in the simulation outcome (e.g., reducing pitch walk variance). For instance, referring to the histogram in FIG. 13 (which is plotted in arbitrary nm units) a section of the experimental parameter data (in this case for the sensitive parameter CDMandrel) is bounded/clamped (μ+kσ(k=−3,3)) to cut the edges of the population distribution. The resulting outcome distributions from performing the Monte Carlo simulations on that bounded population are shown in the histogram in FIG. 14. As shown in FIG. 14, by bounding/clamping the Monte Carlo population, there is now little if any mean shift in the simulation population distribution with respect to the experimental population distribution. For instance, as shown in FIG. 15, the continuous change (i.e., improvement of the pitch walk process) of the standard deviation of the pitch walk population as a function of the clamped kσ width of an experimental parameter. As such, improved process line control for outcome distributions (e.g., SAQP pitch walk) can be achieved by restricting kσ limits of the most sensitive parameters.

Finally, in step 108 the fabrication process is modified (or suggestions can be made to modify) based on the outcome from steps 102-106 with the goal being to improve the output (e.g., reduce pitch walk variation in the output) thereby optimizing the fabrication process. For instance, as described above, the sensitive parameters of the process (e.g., CD_{Mandrel}, T_{Spacer1}, etc. for the exemplary SAQP process) have now been identified using actual experimental parameter data, as well as the relative impact these sensitive parameters have on the outcome (e.g., CD_{Mandrel} variance has a greater impact on pitch walk variance than does T_{Spacer1}).

The impact of bounding the Monte Carlo population (e.g., by cut the edges of the distribution) of these sensitive parameters has on improving the output has also now been determined. This bounding process can be applied directly to the actual fabrication process. For instance, during fabrication measurements of the sensitive parameters are made. Based on the measurements, those outlying samples with sensitive parameter values that were cut from the edges of the population distribution are either discarded or re-worked/fixed such that only those samples within specifications are carried forward. Advantageously, based on the present techniques, these determinations can be made early on in the process to avoid costly and time-consuming downstream steps being performed on non-conforming samples.

For instance, using the above SAQP example, the Monte Carlo population for CD_{Mandrel} was bounded by μ+kσ(k=−3,3). Thus, during fabrication any samples having CD_{Mandrel} values that were cut from the population can be discarded/re-worked to improve the output pitch walk variance. Further, the mandrels are placed early on in the SAQP process. Thus, much effort and expense can be saved by identifying outliers early on in the process.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Turning now to FIG. 16, a block diagram is shown of an apparatus 1600 for implementing one or more of the methodologies presented herein. By way of example only, apparatus 1600 can be configured to implement one or more of the steps of methodology 100 of FIG. 1 and/or one or more steps of methodology 600 of FIG. 6.

Apparatus 1600 includes a computer system 1610 and removable media 1650. Computer system 1610 includes a processor device 1620, a network interface 1625, a memory 1630, a media interface 1635 and an optional display 1640. Network interface 1625 allows computer system 1610 to connect to a network, while media interface 1635 allows computer system 1610 to interact with media, such as a hard drive or removable media 1650.

Processor device 1620 can be configured to implement the methods, steps, and functions disclosed herein. The memory 1630 could be distributed or local and the processor device 1620 could be distributed or singular. The memory 1630 could be implemented as an electrical, magnetic or optical memory, or any combination of these or other types of storage devices. Moreover, the term “memory” should be construed broadly enough to encompass any information able to be read from, or written to, an address in the addressable space accessed by processor device 1620. With this definition, information on a network, accessible through network interface 1625, is still within memory 1630 because the processor device 1620 can retrieve the information from the network. It should be noted that each distributed processor that makes up processor device 1620 generally contains its own addressable memory space. It should also be noted that some or all of computer system 1610 can be incorporated into an application-specific or general-use integrated circuit.

Optional display 1640 is any type of display suitable for interacting with a human user of apparatus 1600. Generally, display 1640 is a computer monitor or other similar display.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for optimizing a semiconductor fabrication process, the method comprising the steps of:
providing a model of the fabrication process;
identifying sensitive parameters of the fabrication process using Monte Carlo simulations that sample sections of experimental parameter populations from the fabrication process as input to the model to determine parameters which impact an outcome of the Monte Carlo simulations, wherein the parameters which impact the outcome of the Monte Carlo simulations are the sensitive parameters;
bounding the experimental parameter populations of the sensitive parameters to improve the outcome of the Monte Carlo simulations; and
modifying the fabrication process based on the providing, identifying and bounding steps to improve an output of the fabrication process.

2. The method of claim 1, wherein the fabrication process comprises a Self-Aligned Quadruple Patterning (SAQP) process, and wherein the output of the fabrication process is pitch walk variance.

3. The method of claim 1, wherein each of the experimental parameter populations comprises kσ bins, wherein a is a standard deviation.

4. The method of claim 3, wherein the identifying step comprises the steps of:
selecting an input parameter of the fabrication process;
limiting an experimental parameter population of the input parameter to μ+kσ{where k=(−4,−3), (−3,−2) . . . (3,4)} to sample a section of the experimental parameter population of the input parameter for the Monte Carlo simulations; and
sampling another section of the experimental parameter population of the input parameter.

5. The method of claim 4, further comprising the steps of:
selecting another input parameter of the fabrication process; and
repeating the selecting, limiting and sampling steps with the other input parameter of the fabrication process.

6. The method of claim 3, wherein the bounding step comprises the steps of:
cutting edges of the experimental parameter populations of the sensitive parameters.

7. The method of clam 6, wherein the Monte Carlo simulations sample sections μ+kσ{for k=(−4,4), (−3,3), (−2,2), (−1,1)} of the experimental parameter populations of the sensitive parameters.

8. The method of claim 1, wherein the modifying step comprises the step of:
discarding samples during fabrication having the sensitive parameters outlying the experimental parameter populations that have been bounded.

9. A method for optimizing a semiconductor fabrication process, the method comprising the steps of:
providing a model of the fabrication process;
identifying sensitive parameters of the fabrication process using Monte Carlo simulations that sample sections of experimental parameter populations from the fabrication process as input to the model to determine parameters which impact an outcome of the Monte Carlo simulations, wherein each of the experimental parameter populations comprises kσ bins, wherein σ is a standard deviation, wherein the parameters which impact the outcome of the Monte Carlo simulations are the sensitive parameters, and wherein the identifying step comprises: selecting an input parameter of the fabrication process, limiting an experimental parameter population of the input parameter to μ+kσ{where k=(−4,−3), (−3,−2) . . . (3,4)} to sample a section of the experimental parameter population of the input parameter for the Monte Carlo simulations, and sampling another section of the experimental parameter population of the input parameter;
bounding the experimental parameter populations of the sensitive parameters to improve the outcome of the Monte Carlo simulations; and
modifying the fabrication process based on the providing, identifying and bounding steps to improve an output of the fabrication process.

10. The method of claim 9, further comprising the steps of:
selecting another input parameter of the fabrication process; and
repeating the selecting, limiting and sampling steps with the other input parameter of the fabrication process.

11. The method of claim 9, wherein the bounding step comprises the steps of:
cutting edges of the experimental parameter populations of the sensitive parameters.

12. The method of clam 11, wherein the Monte Carlo simulations sample sections μ+kσ{for k=(−4,4), (−3,3), (−2,2), (−1,1)} of the experimental parameter populations of the sensitive parameters.

13. The method of claim 9, wherein the modifying step comprises the step of:
discarding samples during fabrication having the sensitive parameters outlying the experimental parameter populations that have been bounded.

14. A computer program product for optimizing a semiconductor fabrication process, the computer program product comprising a computer readable storage medium having program instructions embodied therewith, the program instructions executable by a computer to cause the computer to perform the steps of:
providing a model of the fabrication process;
identifying sensitive parameters of the fabrication process using Monte Carlo simulations that sample sections of experimental parameter populations from the fabrication process as input to the model to determine parameters which impact an outcome of the Monte Carlo simulations, wherein the parameters which impact the outcome of the Monte Carlo simulations are the sensitive parameters;
bounding the experimental parameter populations of the sensitive parameters to improve the outcome of the Monte Carlo simulations; and
suggesting modifications to the fabrication process based on the providing, identifying and bounding steps to improve an output of the fabrication process, and wherein, based on the modifications suggested, samples during fabrication having the sensitive parameters outlying the experimental parameter populations that have been bounded are discarded.

15. The computer program product of claim 14, wherein the fabrication process comprises a SAQP process, and wherein the output of the fabrication process is pitch walk variance.

16. The computer program product of claim 14, wherein each of the experimental parameter populations comprises kσ bins, wherein a is a standard deviation.

17. The computer program product of claim 16, wherein the program instructions, when identifying the sensitive parameters, further cause the computer to perform the steps of:
selecting an input parameter of the fabrication process;
limiting an experimental parameter population of the input parameter to μ+kσ{where k=(−4,−3), (−3,−2) . . . (3,4)} to sample a section of the experimental parameter population of the input parameter for the Monte Carlo simulations; and
sampling another section of the experimental parameter population of the input parameter.

18. The computer program product of claim 17, wherein the program instructions further cause the computer to perform the steps of:
selecting another input parameter of the fabrication process; and
repeating the selecting, limiting and sampling steps with the other input parameter of the fabrication process.

19. The computer program product of claim 14, wherein the program instructions, when bounding the experimental parameter populations, further cause the computer to perform the step of:
cutting edges of the experimental parameter populations of the sensitive parameters.

20. The computer program product of claim 19, wherein the Monte Carlo simulations sample sections μ+kσσ{for k=(−4,4), (−3,3), (−2,2), (−1,1)} of the experimental parameter populations of the sensitive parameters.
